(19) United States
(12) Patent Application Publication
(10) Pub. No.: US 2017/0062144 A1
(43) Pub. Date: Mar. 2, 2017

(54) MANUFACTURING PROCESSES FOR FORMING METALLIZED FILM CAPACITORS AND RELATED METALLIZED FILM CAPACITORS

(71) Applicant: General Electric Company, Schenectady, NY (US)

(72) Inventors: Daniel Qi Tan, Rexford, NY (US); Ri-an Zhao, Niskayuna, NY (US); Jeffrey S. Sullivan, Rexford, NY (US); Lili Zhang, Niskayuna, NY (US); Kevin Warner Flanagan, Troy, NY (US)

(21) Appl. No.: 14/842,426

(22) Filed: Sep. 1, 2015

(51) Int. Cl. H01G 13/00; H01G 4/08

(52) U.S. Cl. CPC H01G 13/00; H01G 4/08

(57) ABSTRACT

A process for forming a capacitor is presented. The process includes providing a laminate including a dielectric layer disposed on a sacrificial substrate, forming a free-standing metallized dielectric layer and packaging the free-standing metallized dielectric layer to form a capacitor. The dielectric layer includes a polyetherimide. The step of forming the free-standing metallized dielectric layer is performed by: (a) disposing a metal layer on the dielectric layer to form a metalized laminate such that a metalized dielectric layer is formed on the sacrificial substrate, and removing the sacrificial substrate to form the free-standing metallized dielectric layer; or (b) removing the sacrificial substrate from the laminate to form a free-standing dielectric layer, and disposing a metal layer on the free-standing dielectric layer to form the free-standing metallized dielectric layer. A capacitor formed by the process is presented. A process for forming a capacitor by a roll-to-roll processing technique is also presented.

### BACKGROUND

The disclosure relates generally to film capacitors. More particularly, the disclosure relates to manufacturing processes for forming metallized film capacitors and capacitors formed therefrom.

Over the last decade, significant improvements in capacitor reliability have been achieved through a combination of advanced manufacturing techniques and new materials. Enhanced performance has been obtained particularly in so-called film capacitors, such as metallized film capacitors.

Compared to other types of film capacitors, metallized film capacitors may provide certain advantages such as size, simplicity, and cost of manufacturing, and hence have been widely used in the power electronics industry. Typically, metallized film capacitors include two metal electrodes separated by a polymer film. An example of the commonly used polymer film includes polypropylene. However, polypropylene-based film capacitors may have challenges in high-temperature industrial applications because of polypropylene's inherent temperature limitations. Polyetherimide (PEI) resins have been recently considered as potential dielectric materials for the film capacitors because PEI resins exhibit significantly higher glass transition temperatures when compared to conventionally used polymers (such as, polypropylene). Polymer films formed using the PEI resins may have one or more of the desired characteristics for a film capacitor such as high temperature stability, desired heat resistance, desired voltage resistance, high dielectric breakdown voltage, high dielectric constant, and low dielectric loss.

Moreover, thinner polymer films (for example, with thickness less than 10 microns) are desirable to reduce both the cost and volume. However, the known methods for forming thin polymer films, for example, melt extrusion molding or blown extrusion molding, have challenges in providing good quality PEI thin films, specifically, in providing a wrinkle-free film with high thickness accuracy and uniformity in a wound form. The wrinkles produced in the high temperature PEI film may cause one or more of a voltage stress in the wound capacitor, an uneven electrical performance of the metallized end connection, and an inconsistent capacitance. Efforts have been made to reduce the film friction in the extrusion process to avoid the wrinkling in the PEI films by, for example, adding friction-reducing slip agent additives in the PEI resins, or utilizing textured imprints on the cooling mandrel. However, these techniques may adversely affect some performance characteristics of the PEI film.

Thus, there is a need for improved manufacturing processes to form metallized film capacitors including thin PEI films, and metallized film capacitors formed therefrom.

### BRIEF DESCRIPTION

In some embodiments, a process for forming a capacitor is presented. The process includes providing a laminate including a dielectric layer disposed on a sacrificial substrate, forming a free-standing metallized dielectric layer and packaging the free-standing metallized dielectric layer to form the capacitor. The dielectric layer includes a polyetherimide. The step of forming the free-standing metallized dielectric layer itself is performed by: (a) disposing a metal layer on the dielectric layer to form a metalized laminate such that a metalized dielectric layer is formed on the sacrificial substrate, and removing the sacrificial substrate to form the free-standing metallized dielectric layer; or (b) removing the sacrificial substrate from the laminate to form a free-standing dielectric layer, and disposing a metal layer on the free-standing dielectric layer to form the free-standing metallized dielectric layer. Some embodiments relate to a capacitor that is formed by the process.

In some embodiments, a process of forming a capacitor is performed by using a roll-to-roll processing technique. The process includes:

treating a surface of a sacrificial substrate and winding the treated sacrificial substrate to form a first core;

transferring the treated sacrificial substrate from the first core to a first deposition apparatus;

disposing an organic dielectric layer on the surface of the treated sacrificial substrate in the first deposition apparatus with a first roll-to-roll set up to form a laminate, wherein the organic dielectric layer includes a polyetherimide;

winding the laminate to form a second core;

transferring the laminate from the second core to a second deposition apparatus;

disposing an additional dielectric layer on the organic dielectric layer in the second deposition apparatus with a second roll-to-roll set up to form a capped laminate;

winding the capped laminate to form a third core;

transferring the capped laminate from the third core to a third deposition apparatus;

metallizing the capped laminate in the third deposition apparatus with a third roll-to-roll set up to form a metallized laminate such that a metallized dielectric layer is disposed on the sacrificial substrate;

winding the metallized laminate to form a fourth core;

unwinding the fourth core and removing the sacrificial substrate to form a free-standing metallized dielectric layer; and

winding the free-standing metallized dielectric layer of a suitable dimension to form the capacitor.

### DRAWINGS

These and other features, aspects, and advantages of the present invention will become better understood when the following detailed description is read with reference to the accompanying drawings in which like characters represent like parts throughout the drawings, wherein:

FIG. 1 is a flow chart of a process for forming a capacitor, in accordance with some embodiments;

FIG. 2 schematically shows the laminates and film structures formed after completion of one or more process steps of the process of FIG. 1, in accordance with some embodiments;

FIG. 3 schematically shows the laminates and film structures formed after completion of one or more process steps of the process of FIG. 1, in accordance with some embodiments;

FIG. 4 schematically shows the laminates and film structures formed after completion of one or more process steps of the process of FIG. 1, in accordance with some embodiments;

FIG. 5 schematically shows the laminates and film structures formed after completion of one or more process steps of the process of FIG. 1, in accordance with some embodiments;

FIG. 6 schematically shows the laminates and film structures formed after completion of one or more process steps of the process of FIG. 1, in accordance with some embodiments;

FIG. 7 illustrates a wound capacitor, in accordance with some embodiments;

FIG. 8 illustrates a multilayer configuration of the wound capacitor, in accordance with some embodiments;

FIG. 9 is a flow chart of a process for forming a capacitor by roll-to-roll processing technique, in accordance with some embodiments; and

FIG. 10 schematically shows the process steps including the laminates and film structures formed after completion of one or more process steps of the process of FIG. 9, in accordance with some embodiments.

### DETAILED DESCRIPTION

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

Unless defined otherwise, technical and scientific terms used herein have the same meaning as is commonly understood by one of skill in the art to which this invention belongs. The terms “comprising,” “including,” and “having” are intended to be inclusive, and mean that there may be additional elements other than the listed elements. The terms “first”, “second”, and the like, as used herein do not denote any order, quantity, or importance, but rather are used to distinguish one element from another.

As used herein, the term “layer” refers to a thin film drawn from material or produced by disposing a material on at least a portion of an underlying surface, in a continuous or discontinuous manner. The terms “layer” and “film” are interchangeably used herein, throughout the specification. Further, the term “layer” or “film” does not necessarily mean a uniform thickness of the disposed material. The disposed material may have a uniform or variable thickness. Furthermore, the term “a layer” as used herein refers to a single layer or a plurality of layers, unless the context clearly dictates otherwise. In the present disclosure, when a layer is being described as “disposed on” another layer or substrate, it is to be understood that the layers can either be directly contacting each other or have one (or more) layer between the layers. Further, the term “on” describes the relative position of the layers to each other and does not necessarily mean “on top of” since the relative position above or below depends upon the orientation of the resulting article to the viewer. Moreover, the use of “top,” “bottom,” “above,” “below,” and variations of these terms is made for convenience, and does not require any particular orientation of the components unless otherwise stated.

In some embodiments, a process for forming a capacitor is presented. The capacitor may be a metallized film capacitor. A metallized film capacitor generally includes a dielectric layer interposed between two electrodes on either side. The dielectric layer usually includes a polymer layer. The two electrodes may include a layer of a metal such as aluminum, copper, or zinc, which are vacuum deposited on the dielectric film. The metal layer is usually thin, and may have a thickness of about 200-500 angstroms.

In a typical construction of a metallized film capacitor, the capacitor includes a metallized dielectric layer (for example, a polymer layer) wound in a cylindrical configuration of the capacitor. Technology used for constructing such a capacitor is referred to as the “wound” capacitor technology, and the capacitor is referred to as the “wound capacitor.” In the “wound” capacitor technology, offset lengths of the metallized dielectric layers are wound in a rolled cylindrical configuration. The dielectric layer may be metallized on one side (that is, on one surface) or on both the sides to form the metallized dielectric layer, and the corresponding film capacitors are referred to as a single-sided metallized film capacitor or a double-sided metallized film capacitor.

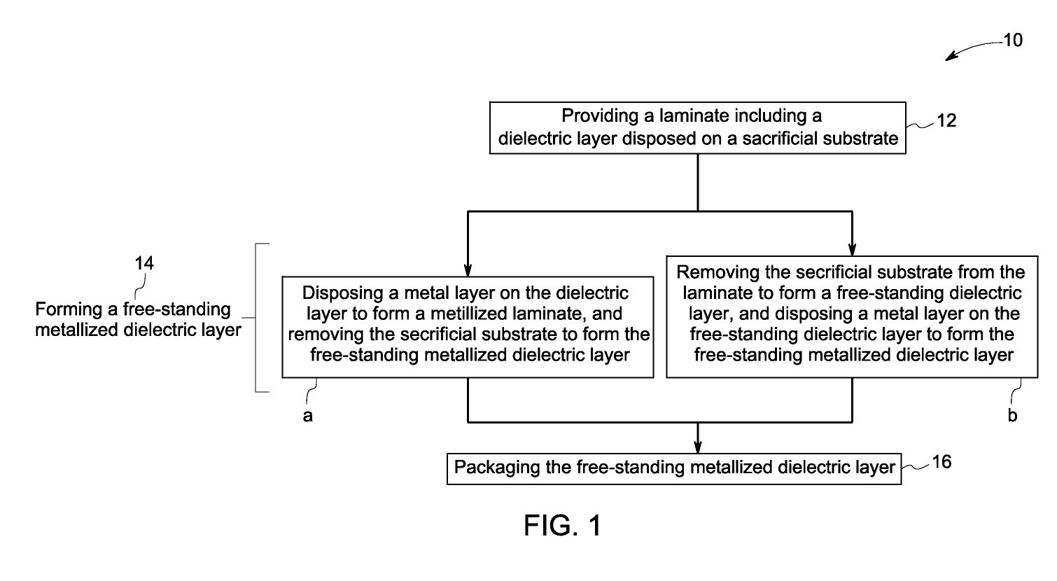

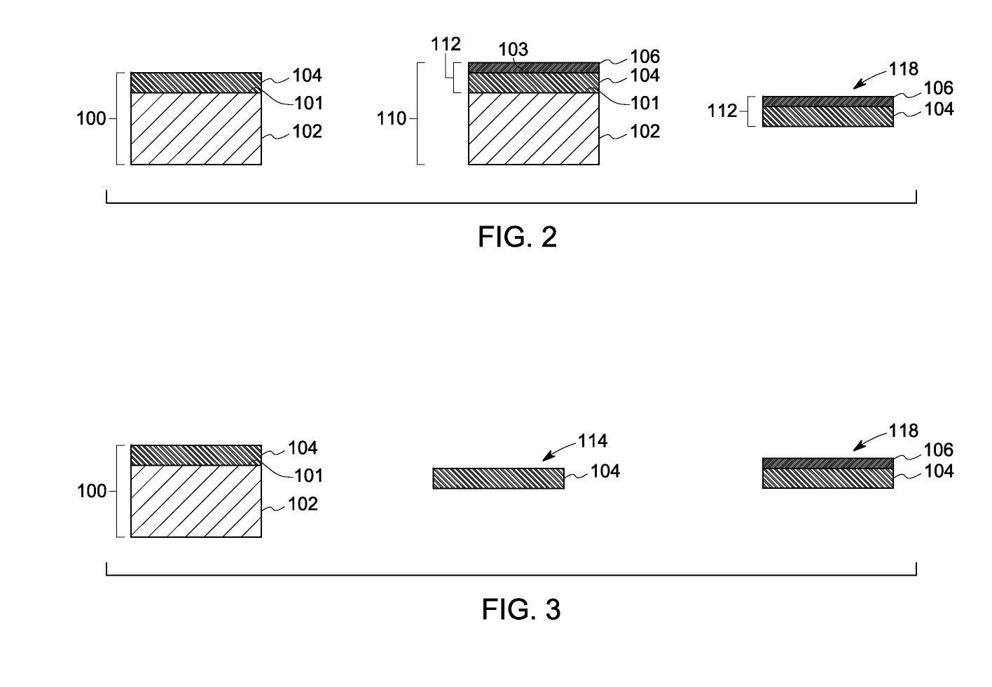

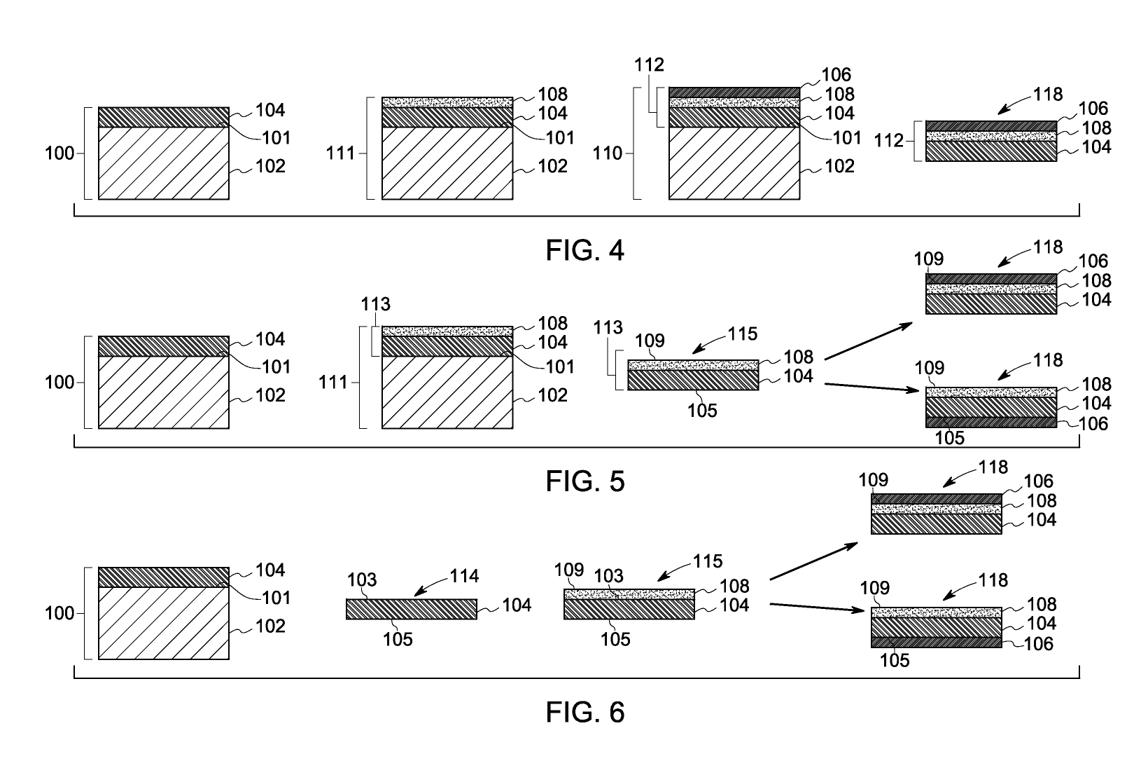

FIG. 1 shows a flow chart of a process 10 for forming a capacitor 120 (shown in FIG. 4), in accordance with some embodiments of the invention. The laminates or film structures formed after the completion of one or more process steps of the process 10, are schematically depicted in FIGS. 2 and 3. Referring to FIGS. 1-3, in some embodiments, the process 10 includes a step 12 of providing a laminate 100, a step 14 of forming a free-standing metallized dielectric layer 118, and a step 16 of packaging the free-standing metallized dielectric layer 118 to form the capacitor 120. In some embodiments, the step 14 of forming the free-standing metallized dielectric layer 118 is performed using a roll-to-roll processing technique. In some embodiments, one or more process steps of the process 10 for forming the capacitor 120 are performed using a roll-to-roll processing technique. In some embodiments, the entire process 10 for forming the capacitor 120 is performed using a roll-to-roll processing technique. Use of a roll-to-roll processing technique may allow for more cost-effective production of the capacitors.

Referring again to FIGS. 1-3, the laminate 100 includes a dielectric layer 104 disposed on a sacrificial substrate 102. The terms “provide a laminate” or “providing a laminate” as used herein refer to either disposing the dielectric layer 104 on the sacrificial substrate 102 or procuring a pre-fabricated laminate 100.

As used herein, the term, ‘sacrificial substrate’ refers to a substrate that provides sufficient mechanical strength and flexibility for one or more dielectric layers disposed on the substrate. The sacrificial substrate further provides mechanical support to the dielectric layer(s) during the several processing steps, for example formation or deposition of the dielectric layer(s), metallization, and winding and unwinding steps during roll-to-roll processing (as discussed below). As described herein, the sacrificial substrate is removed or separated from a dielectric layer, a capped dielectric layer or a metallized dielectric layer during the process of forming the free-standing metallized dielectric layer, for example before or after the formation of additional layers, and hence referred to as “sacrificial substrate.”

The sacrificial substrate 102 may include a polymer, a metal or a combination thereof. In some embodiments, a material for the sacrificial substrate 102 is selected such that an effective adhesion strength between the sacrificial substrate 102 and the dielectric layer 104 is achieved. In some embodiments, the sacrificial substrate 102 includes a polymer selected from the group consisting of polyester, polypropylene, polyetherimide, polyimide, polyphenylene sulfide, polyethylene naphthalate, polysulfone, polyethersulfone, polycarbonate, polyetheretherketone, polystyrene, polyethylene, and combinations thereof. In particular embodiments, the sacrificial substrate 102 includes polyethylene terephthalate (PET) or paper. In some embodiments, the sacrificial substrate 102 includes a metal selected from the group consisting of steel, aluminum, copper, zinc, or combinations thereof. In these instances, the sacrificial substrate 102 may be a metal foil.

Moreover, the sacrificial substrate 102 has a thickness suitable to provide sufficient mechanical support to the dielectric layer 104. In some embodiments, the sacrificial substrate 102 has a thickness of at least about 10 microns. Suitable thickness of the sacrificial substrate 102 may be in a range from about 10 microns to about 500 microns.

As noted previously, the dielectric layer 104 is disposed on the sacrificial substrate 102. The dielectric layer 104 includes a polyetherimide. Non-limiting examples of suitable polyetherimides include ULTEM® 1000 resin series, ULTEM® 5000 resin series, and ULTEM® CRS 5000 resin series. In some particular embodiments, the dielectric layer 104 consists essentially of a polyetherimide. The term “consists essentially of” as used herein means that the dielectric layer primarily includes a polyetherimide and does not include additional materials, such as, metal or semiconductor particles that may alter the properties of the dielectric layer 104. In some instances, the dielectric layer 104 may include a small quantity (less than about 0.1 percent) of contaminants. In some particular embodiments, the dielectric layer 104 is made of a polyetherimide.

In some embodiments, the process 10 further includes a step of disposing the dielectric layer 104 on a surface 101 of the sacrificial substrate 102. The dielectric layer 106 may be disposed on the sacrificial substrate 102 by any suitable process (for example, a deposition process) known in the art. Suitable examples of the processes include, but are not limited to, extrusion, chemical vapor deposition, physical vapor deposition (for example, sputtering), casting, dip coating, spin coating, and combinations thereof. In some embodiments, the dielectric layer 104 is formed using melt extrusion. In some embodiments, the step 12 of providing the laminate 100 includes extruding the dielectric layer 104, and disposing the extruded dielectric layer 104 on the sacrificial substrate 102 simultaneously (in-situ) or after extruding the dielectric layer 104.

In some embodiments, the dielectric layer 104 has a thickness in a range from about 0.1 micron to about 20 microns. As mentioned previously, in certain configurations of the capacitor, the dielectric layer 104 having the thickness of less than about 10 microns may be desirable to achieve desirably high capacitance within a desirable volume. In some particular embodiments, the thickness of the dielectric layer 104 is in a range from about 0.5 micron to about 7 microns.

In embodiments wherein the thickness of the dielectric layer 104 is less than 5 microns, the layer 104 may be disposed on the sacrificial substrate 102 directly, that is, during the formation or deposition process of the dielectric layer itself. Non-limiting examples of suitable techniques for such embodiments include a solution based deposition process or a melt extrusion process. In particular embodiments, a polyetherimide film is directly melt extruded on the sacrificial substrate 102. In some other embodiments, wherein the dielectric layer 104 has a thickness greater than 5 microns, the dielectric layer 104 may be first formed by a suitable process, and thereafter disposed on the sacrificial substrate 102 to form the laminate 100.

The thickness and uniformity of the dielectric layer 104 may be controlled in part through solvent selection, solution viscosity, and various other process parameters as known in the art. The formation or deposition process of the dielectric layer 104 may be followed by a heating step to remove the solvents used in the solutions. In some instances, a thickness variation across the dielectric layer 104 is less than about 10 percent. Moreover, the quality of the dielectric layer 104 may be improved by controlling the process conditions. For example, by performing the deposition process in a clean room environment, a high quality dielectric layer may be obtained. In one embodiment, the dielectric layer 104 has a breakdown strength of at least about 300 kV/mm. In a particular embodiment, the dielectric layer 104 has a breakdown strength in a range from about 300 kV/mm to about 1000 kV/mm.

In some embodiments, the step 12 of providing the laminate 100 further includes treating the surface 101 of the sacrificial substrate 102 before disposing the dielectric layer 104 on the treated surface 101 of the sacrificial substrate 102. In one particular embodiment, the surface 101 is treated by a corona discharge treatment. Corona discharge treatment (CDT) is a surface modification technique that uses a low temperature corona discharge plasma to impart property changes to a surface.

In some embodiments, the surface 101 of the substrate 102 is treated such that an effective adhesion strength between the sacrificial substrate 102 and the dielectric layer 104 is achieved. As used herein, the term “effective adhesion strength” refers to an adequate adhesion strength that retains the dielectric layer 104 on the sacrificial substrate 102 during several subsequent processing steps (for example, deposition of an additional dielectric layer and a metal layer, slitting, and capacitor winding during packaging); and further allows reliable separation of the sacrificial substrate 102 from the dielectric layer 104 during any step of the process of forming the free-standing metallized dielectric layer 118. In some embodiments, the effective adhesion strength between the dielectric layer 104 and the sacrificial substrate 102 is such that the sacrificial substrate 102 can be peeled manually or using the standard stripping processes. In some embodiments, the effective adhesion strength further enables the laminate 100 or the metallized laminate 110 to be wound and unwound without delamination, for example during the roll-to-roll processing of the capacitor.

An adhesion of the dielectric layer 104 to the sacrificial substrate 102 may be controlled, in part, by the power employed during the corona discharge treatment (CDT power). It was observed that when the CDT power is high, for example higher than 5 kWatt, it was difficult to strip and peel a metallized dielectric layer 112 from the sacrificial substrate 102 using the standard stripping processes. A low CDT power provided low adhesion that was desirable to create a strippable dielectric layer on the sacrificial substrate 102. In some embodiments, the effective adhesion strength between the sacrificial substrate 102 and the dielectric layer 104 is in a range from about 0.1 newton/100 millimeters to about 5 newton/100 millimeters. In some embodiments, the effective adhesion strength may be achieved by using a suitable CDT power between about 0.5 kW and about 5 kW.

With continued reference to FIGS. 1-3, the process 10 further includes the step 14 of forming the free-standing metallized dielectric layer 118. The step 14 includes disposing a metal layer 106 on the dielectric layer 104. The step of disposing a metal layer may also be referred to as metallization step. As mentioned previously, the sacrificial substrate 102 is subsequently removed, that is, separated from the dielectric layer 104 to form the free-standing metallized dielectric layer 118. The metallization of the dielectric layer 104 may be performed before or after removing the sacrificial substrate 102 as described in the step 14(a) or step 14 (b) of FIG. 1.

In some embodiments, as illustrated in FIG. 2, the step 14(a) of forming a free-standing metallized dielectric layer includes first disposing the metal layer 106 on the dielectric layer 104 to form a metallized laminate 110. The metallized laminate 110, so formed, includes a metallized dielectric layer 112 disposed on the sacrificial substrate 102. After forming the metallized laminate 110, the step 14(a) further includes removing the sacrificial substrate 102 from the metallized laminate 110 to form the free-standing metallized dielectric layer 118.

In some embodiments, as illustrated in FIG. 3, the step 14(b) of forming a free-standing metallized dielectric layer includes first removing the sacrificial substrate 102 from the laminate 100 to form a free-standing dielectric layer 114, and then disposing the metal layer 106 on a surface of the free-standing dielectric layer 114 to form the free-standing metallized dielectric layer 118.

In some embodiments, the metal layer 106 forms an electrode. Non-limiting examples of suitable metals include aluminum, zinc, copper, or combinations thereof. The metal layer 106 may be disposed by any suitable process known in the art. Examples of suitable processes include, but are not limited to, sputtering, electrochemical deposition, and evaporation deposition.

In some embodiments, the step 14 of forming the free-standing metallized dielectric layer 118 may further include an optional step (not shown in FIG. 1) of disposing an additional dielectric layer 108 on the dielectric layer 104, as depicted in FIGS. 4-6. In some embodiments, the optional step of disposing the additional dielectric layer 108 is performed before disposing the metal layer 106 in the step 14(a) or step 14(b), as illustrated in FIGS. 4-6. That is, the additional dielectric layer 108 is disposed on the dielectric layer 104 before disposing the metal layer 106. In some embodiments, the additional dielectric layer 108 is disposed on the dielectric layer 104 after metallizing a surface of the dielectric layer 104 (not shown in figures).

In some embodiments, wherein the process includes forming a free-standing metallized dielectric layer using step 14(a), the process may further include disposing an additional dielectric layer 108 on the dielectric layer 104 of the laminate 100, as illustrated in FIG. 4. The resulting laminate may be referred to as a capped laminate 111. Further, as depicted in FIG. 4, the metallization is performed by disposing the metal layer 106 on the additional dielectric layer 108 of the capped laminate 111 to form the metallized laminate 110. The metallized laminate 110 includes the metallized dielectric layer 112 (that includes the dielectric layer 104, the additional dielectric layer 108, and the metal layer 106) disposed on the sacrificial substrate 102. The step 14(a) further includes removing the sacrificial substrate 102 from the metallized dielectric layer 112 to form the free-standing metallized dielectric layer 118.

In embodiments wherein the process includes forming a free-standing metallized dielectric layer using step 14(b), the process may further include disposing the additional dielectric layer 108 on the dielectric layer 104 before or after removing the sacrificial substrate 102, as depicted respectively in FIGS. 5 and 6.

In some embodiments, as illustrated in FIG. 5, the process includes disposing the additional dielectric layer 108 on the dielectric layer 104 of the laminate 100. The resulting capped laminate 111 includes a capped dielectric layer 113 disposed on the sacrificial substrate 102. In these embodiments, the step 14 (b) further includes removing the sacrificial substrate 102 to form a free-standing capped dielectric layer 115. The step 14 further includes metallization of the free-standing capped dielectric layer 115 by disposing the metal layer 106 on a surface 109 of the additional dielectric layer 108, or, alternatively, on a surface 105 of the dielectric layer 104 (that is, on the side opposite to that of the additional dielectric layer), thereby forming the free-standing metallized dielectric layer 118.

In some embodiments, as illustrated in FIG. 6, the process includes disposing the additional dielectric layer 108 on the free-standing dielectric layer 114 (for example, formed in FIG. 3) after removing the sacrificial substrate 102 from the laminate 100. In these embodiments, the step 14 (b) further includes metallizing the resulting free-standing capped dielectric layer 115 to thereby forming the free-standing metallized dielectric layer 118. The metal layer 106 may be disposed on the surface 109 of the additional dielectric layer 108, or, alternatively, on a surface 105 of the dielectric layer 104 (that is, on the side opposite to that of the additional dielectric layer), thereby forming the free-standing metallized dielectric layer 118. In some embodiments, the metal layer 106 may be disposed on the surface 105 of the free-standing dielectric layer 114 before disposing the additional dielectric layer 108 on the opposite surface 103 of the free-standing dielectric layer 114, to form the free-standing metallized dielectric layer 118 (embodiment not shown in Figures).

The additional dielectric layer 108 may include an organic or inorganic dielectric material. Examples of suitable inorganic dielectric materials for the additional dielectric layer 108 include, but are not limited to, silicon oxide, silcon nitride, silicon oxynitride, aluminum oxide, titanium oxide, tantalum oxide, yttrium oxide, magnesium oxide, zirconium oxide, strontium titanate, barium strontium oxide, or combinations thereof. Non-limiting examples for organic dielectric materials include acrylate, polyphenylene sulfide (PPS), polyethylene terephthalate (PET). In some particular embodiments, the additional dielectric layer 108 has a thickness that is less than 10 percent of the thickness of the organic dielectric layer 104. In some instances, the additional dielectric layer 108 of thickness less than about 1 micron is desirable. Without being bound by any theory, it is believed that the additional dielectric layer 108 may help in reducing or mitigating surface defects of the dielectric layer 104 (for example, a PEI layer) and hence may improve the breakdown strength of the dielectric layer.

The additional dielectric layer 108 may be disposed on the dielectric layer 104 by any suitable deposition process known in the art. Examples include physical vapor deposition techniques, such as radio frequency (RF) magnetron sputtering, reactive sputtering, electron-beam evaporation, and heat lamination. In some embodiments, RF magnetron sputtering is used for the deposition of the additional dielectric layer 108. One skilled in the art would be able to choose the additional dielectric layer material and the coating process based on the specific application. For example, an acrylate layer of thickness about 0.5 micron can be disposed on the dielectric layer 104 by a vapor deposition or heat lamination technique.

As discussed in above embodiments, the sacrificial substrate 102 is removed during any processing step of the process step 14. The sacrificial substrate 102 may be removed by peeling the dielectric layer 104, the capped dielectric layer or the metallized dielectric layer 112, either manually, or by using a standard stripping process. As noted previously, a desired effective adhesion strength between the sacrificial substrate 102 and the dielectric layer 104 enables the separation of the corresponding dielectric layer from the sacrificial substrate 102.

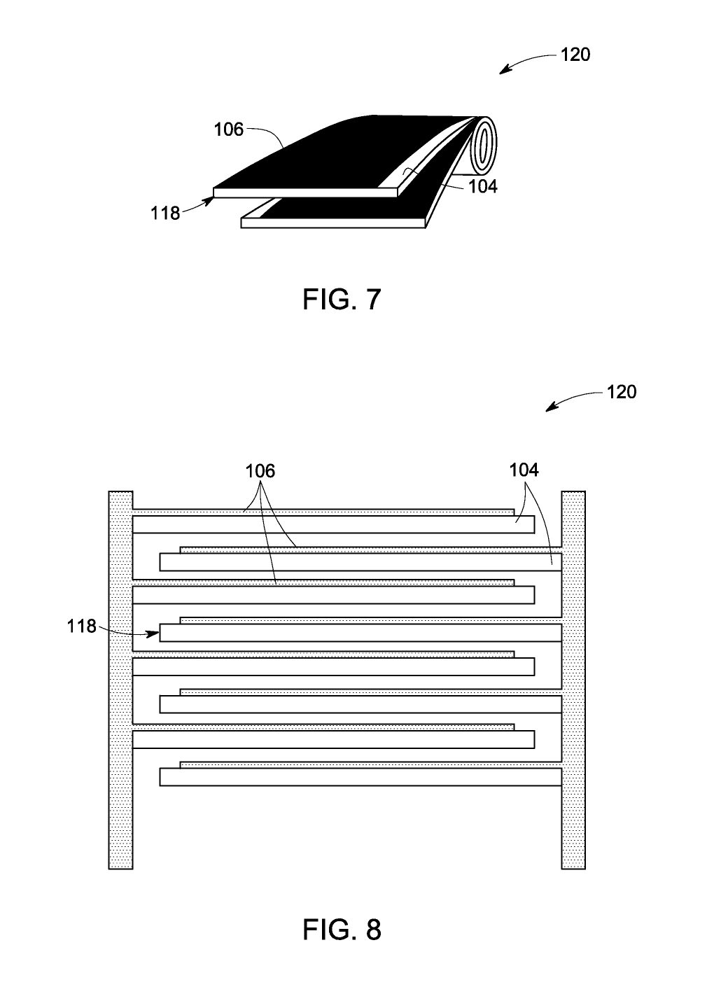

The process 10 further includes the step 16 of packaging the free-standing metallized dielectric layer 118 to form the capacitor 120, for example a metallized film capacitor, as shown in FIGS. 1 and 7. In some embodiments, the packaging step 16 includes winding the free-standing metallized dielectric layer 118 for packaging of the capacitor in a configuration as known in the art. In one embodiment, the capacitor 120 is a wound capacitor as illustrated in FIG. 7. In some embodiments, multiple free-standing metallized dielectric layers 118 are wound around a cylindrical surface (not shown) in a configuration as shown in FIG. 8, and packaged to form the wound capacitor.

As noted previously, a roll-to-roll processing technique may be used for performing one or more process steps described herein. Use of this processing technique may be cost effective for the production of the capacitors.

In some embodiments, a capacitor formed by the process as discussed above, is presented.

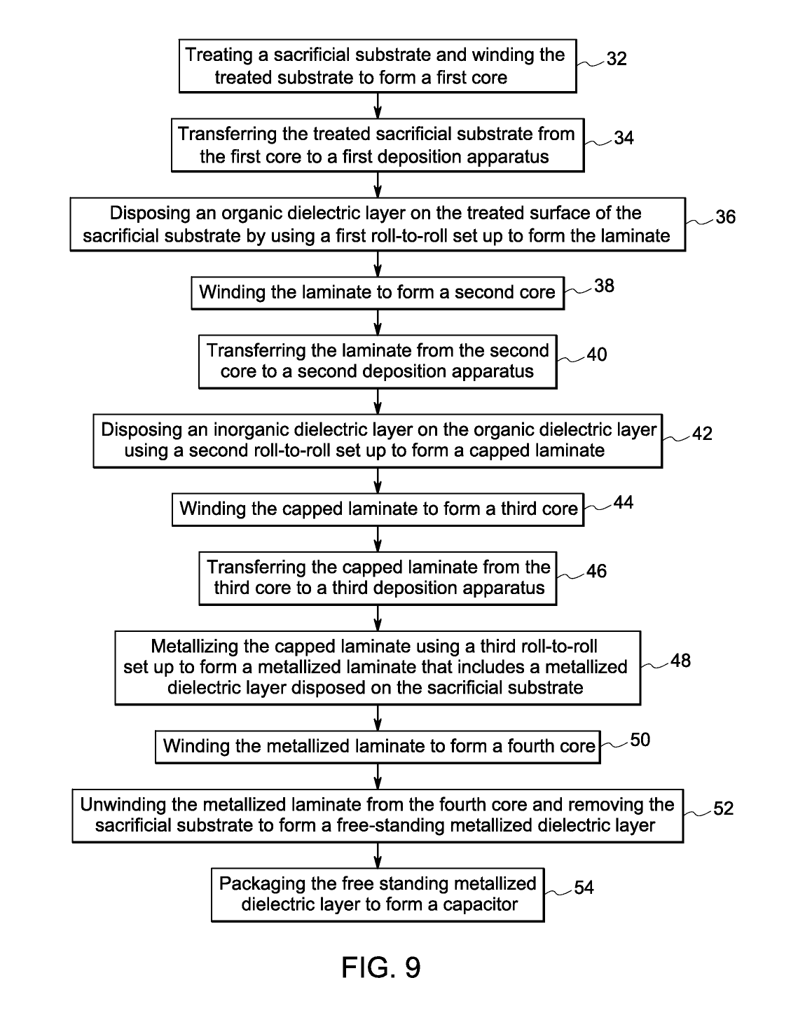

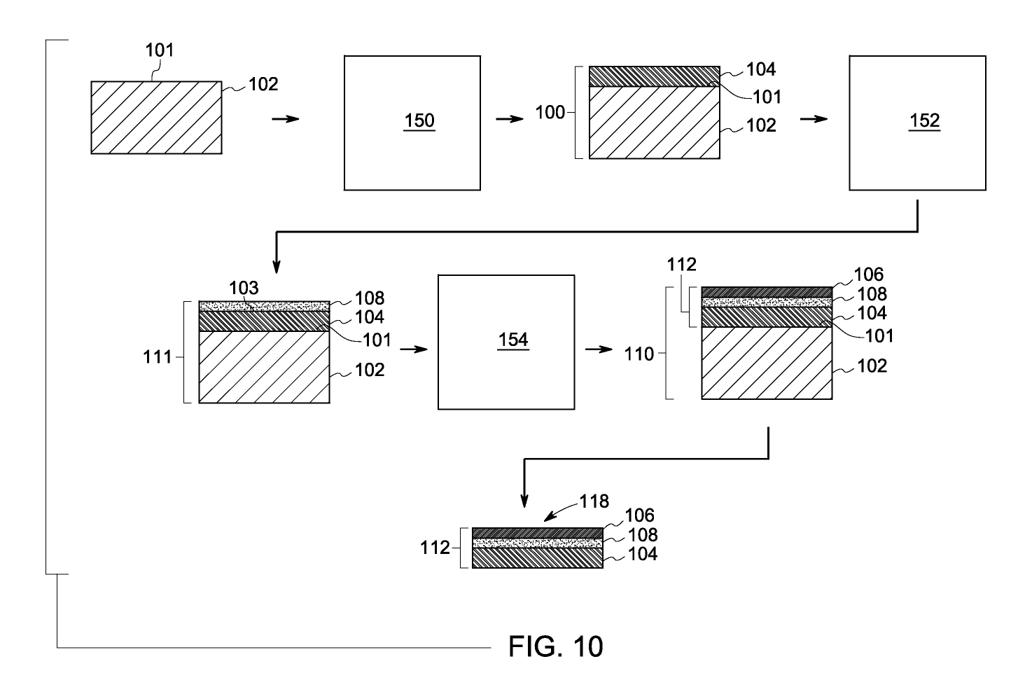

FIG. 9 is a flow chart depicting a process 30 for forming a capacitor using a roll-to-roll processing technique, in accordance with some embodiments of the invention. FIG. 10 schematically shows the process steps including laminate structures and film structures formed after completion of one or more process steps of the process of FIG. 9. Referring now to FIGS. 9 and 10, in some embodiments, the process 30 includes a step 32 of treating the surface 101 of the sacrificial substrate 102 and winding the treated substrate 102 to form a first core (not shown). The sacrificial substrate 102 is wound in a roll to form the first core. As discussed previously, the surface 101 of the sacrificial substrate 102 may be treated with a corona discharge treatment. In the next step 34, the treated sacrificial substrate 102 is transferred from the first core to a first deposition apparatus 150. The process 30 further includes a step 36 of disposing the organic dielectric layer 104 on the treated surface 101 of the sacrificial substrate 102 to form the laminate 100. The step 36 is performed in the first deposition apparatus 150 using a first roll-to-roll set up (not shown in figures). In some embodiments, the dielectric layer 104 is fabricated by a melt extrusion coating process. In these embodiments, the step 36 includes supplying the treated sacrificial substrate 102 in an extruding equipment, and directly extruding the dielectric layer 104 on the sacrificial substrate 102 from the extruding equipment. By way of example, a method for extruding a polyetherimide layer is described in U.S. Pat. No. 8,524,133. After extrusion, the resulting laminate 100 may be interposed between a pressing roll and a cooling roll to cool the laminate 100. The process 30 further includes winding up the laminate 100 to form a second core (not shown in figures) in step 38.

Various material and deposition/formation process-related details for the sacrificial substrate, the dielectric layer, the additional dielectric layer, and the metal layer are described above.

Referring again to FIGS. 9 and 10, the process 30 further includes, at step 40, transferring the laminate 100 from the second core to a second deposition apparatus 152. The process 30 then includes a step 42 of disposing the additional dielectric layer 108 on the dielectric layer 104 to form a capped laminate 111. The step 42 is performed in the second deposition apparatus 152 using a second roll-to-roll set up (not shown). In some embodiments, a sputtering deposition method may be used for depositing the additional dielectric layer 106. In these embodiments, the laminate 100 from the second core (or roll) is supplied to a vacuum sputter deposition apparatus. After deposition of the additional dielectric layer 108, the process 30 includes a step 44 of winding the resulting capped laminate 111 to form a third core (not shown).

In the next step, 46, the capped laminate 111 from the third core is then transferred to a third deposition apparatus 154. The process 30 then includes a step 48 of metallizing the capped laminate 111 in the third deposition apparatus 154 using a third roll-to-roll set up (not shown in Figures) to form the metallized laminate 110. The metallization of the capped laminate 111 may be carried out by any suitable coating technique, for example, sputtering, electrochemical deposition, or evaporation deposition. After completion of the metallization step 48, the metallized laminate 110 includes the metallized dielectric layer 112 disposed on the sacrificial substrate 102. The process 30 further includes a step 50 of winding the metallized laminate 110 to form a fourth core (not shown).

As described herein, the step of forming each of a first core, second core, third core or fourth core, may refer to winding of a roll to form a core. Each of the first roll-to-roll set up, the second roll-to-roll set up, and the third roll-to-roll set up, may include a large drum on which a substrate (for example, the sacrificial substrate or laminate) remains flat during the deposition process. The drum's temperature can be controlled, usually from about −20 degrees Celsius to 200 degrees Celsius, allowing for elevated temperature processes. A respective substrate or laminate from a corresponding core may be first taped to the drum and the drum may then run from one end of the substrate or the laminate to the other end. The resulting laminate or metallized laminate may be simultaneously wound on another core until the beginning of the core is positioned on the other side of another core. The laminate or the metallized laminate from another core is then transferred to the next step, for example, the next roll-to-roll set up of the process.

With continued reference to FIGS. 9 and 10, the process 30 further includes a step 52 of unwinding the metallized laminate 110 from the fourth core and removing the sacrificial substrate 102 from the metallized dielectric layer 112 to form a free-standing metallized dielectric layer 118. In this step, in some instances, the metallized laminate 110 may be slit in a suitable dimension. In some embodiments, the process 30 includes slitting the metallized laminate 110 in a suitable dimension before or after unwinding the fourth core. After slitting the metallized laminate 110 in the suitable dimension, the sacrificial substrate 102 is removed or separated to form the free-standing metallized dielectric layer 118 of a corresponding suitable dimension. In the next step 54, the process 30 includes packaging the free-standing metallized dielectric layer 118 of the suitable dimension to form a capacitor 120 (FIG. 4). The free-standing metallized dielectric layer 118 may be wound in a configuration as described above in context of FIGS. 4 and 5 while packaging to form a wound capacitor, in some embodiments.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A process, comprising:
providing a laminate comprising a dielectric layer disposed on a sacrificial substrate, wherein the dielectric layer comprises a polyetherimide;
forming a free-standing metallized dielectric layer by:
(a) disposing a metal layer on the dielectric layer to form a metallized laminate such that a metallized dielectric layer is formed on the sacrificial substrate, and removing the sacrificial substrate to form the free-standing metallized dielectric layer; or
(b) removing the sacrificial substrate from the laminate to form a free-standing dielectric layer, and disposing a metal layer on the free-standing dielectric layer to form the free-standing metallized dielectric layer; and
packaging the free-standing metallized dielectric layer to form a capacitor.

2. The process of claim 1, wherein one or more process steps are performed by a roll-to-roll processing technique.

3. The process of claim 1, wherein the sacrificial substrate comprises a polymer selected from the group consisting of polyester, polypropylene, polyetherimide, polyimide, polyphenylene sulfide, polyethylene naphthalate, polysulfone, polyethersulfone, polycarbonate, polyetheretherketone, polystyrene, polyethylene, and combinations thereof.

4. The process of claim 1, wherein the sacrificial substrate comprises a metal selected from the group consisting of aluminum, copper, zinc, and combinations thereof.

5. The process of claim 1, wherein the sacrificial substrate has a thickness of at least about 10 microns.

6. The process of claim 1, wherein the sacrificial substrate has a thickness in a range from about 10 microns to about 500 microns.

7. The process of claim 1, wherein the dielectric layer consists essentially of a polyetherimide.

8. The process of claim 1, wherein the dielectric layer has a thickness in a range from about 0.1 micron to about 20 microns.

9. The process of claim 1, wherein the dielectric layer has a thickness in a range from about 0.1 micron to about 10 microns.

10. The process of claim 1, wherein providing the laminate comprises treating a surface of the sacrificial substrate and disposing the dielectric layer on the treated surface of the sacrificial substrate such that an effective adhesion strength between the sacrificial substrate and the dielectric layer is achieved.

11. The process of claim 10, wherein treating the surface of the sacrificial substrate comprises a corona discharge treatment.

12. The process of claim 10, wherein the effective adhesion strength between the sacrificial substrate and the dielectric layer is in a range from about 0.1 newton/100 millimeters to about 5 newton/100 millimeters.

13. The process of claim 1, wherein providing the laminate comprises extruding the dielectric layer and disposing the extruded dielectric layer on the sacrificial substrate.

14. The process of claim 1, further comprising disposing an additional dielectric layer on the dielectric layer before disposing the metal layer in the step (a) or (b).

15. The process of claim 14, wherein the step of disposing the additional dielectric layer comprises disposing the additional dielectric layer on the dielectric layer before removing the sacrificial substrate in the step (a) or (b).

16. The process of claim 14, wherein the step of disposing the additional dielectric layer comprises disposing the additional dielectric layer on the dielectric layer after removing the sacrificial substrate in the step (a) or (b).

17. The process of claim 14, wherein the additional dielectric layer comprises an organic or inorganic dielectric material.

18. A capacitor formed by the process according to claim 1.

19. The capacitor of claim 18, wherein the dielectric layer consists essentially of a polyetherimide.

20. The capacitor of claim 18, wherein the dielectric layer has a thickness in a range from about 0.1 micron to about 10 microns.

21. A process, comprising:
treating a surface of a sacrificial substrate and winding the treated sacrificial substrate to form a first core;
transferring the treated sacrificial substrate from the first core to a first deposition apparatus;
disposing a dielectric layer on the surface of the treated sacrificial substrate in the first deposition apparatus with a first roll-to-roll set up to form a laminate, wherein the dielectric layer comprises a polyetherimide;
winding the laminate to form a second core;
transferring the laminate from the second core to a second deposition apparatus;
disposing an additional dielectric layer on the dielectric layer in the second deposition apparatus with a second roll-to-roll set up to form a capped laminate;
winding the capped laminate to form a third core;
transferring the capped laminate from the third core to a third deposition apparatus;
metallizing the capped laminate in the third deposition apparatus with a third roll-to-roll set up to form a metallized laminate such that a metallized dielectric layer is disposed on the sacrificial substrate;
winding the metallized laminate to form a fourth core;
unwinding the fourth core and removing the sacrificial substrate to form a free-standing metallized dielectric layer; and
winding the free-standing metallized dielectric layer of a suitable dimension to form a capacitor.

22. The process of claim 21, further comprising slitting the metallized laminate in the suitable dimension, before or after unwinding the fourth core.
